(19) United States
(12) Patent Application Publication
(10) Pub. No.: US 2004/0180312 A1
(43) Pub. Date: Sep. 16, 2004

(54) Instructive system for encouraging self actualization

(76) Inventors: Ida M. Covi, Cave Creek, AZ (US); Shane T. Wheel, Cave Creek, AZ (US)

Correspondence Address: Schmeiser, Olsen & Watts LLP, 18 E. University Dr. #101, Mesa, AZ, 85201, US

(21) Appl. No.: 10/261,438

(22) Filed: Sep. 30, 2002

(51) Int. Cl. G09B 19/00

(52) U.S. Cl. 434/236

(57) ABSTRACT

An educational method is disclosed to aid students in finding greater satisfaction in life through greater understanding of how the student's experiences, perceptions, characteristics, fears and the development and implementation of the student's Will affect the student's attitudes and ability to succeed. Embodiments of the invention comprise the use of adventure, imagery, inquiry and explanation to engage the student in psychoanalytical methods of communication to allow the student to reflect upon the student's answers to introspective questions at a “safe” distance. Specific exemplary embodiments of the invention include embodying the invention as a book, an interactive action video game, an audio book, a seminar, a media presentation, an interactive storyboard, an interactive adventure park, a theme park, and an Internet link.

### BACKGROUND OF THE INVENTION

1. Technical Field

The invention generally relates to an educational system for teaching others the skills and knowledge necessary to learn about themselves through introspection and to actualize their desires. More specifically, the system uses psychoanalytical methods for communicating with others through an adventure story, images and introspective questions to teach, motivate and encourage self understanding and improvement.

2. Background Art

Many throughout the world are or should be seeking personal direction in life to achieve greater satisfaction from life. Does life have a purpose? How can I make a difference? What ought I do? These are questions that have occurred to many people, in all walks of life. Whether it be a teenager currently dealing with the pressures of home and school life who should be setting goals toward a successful future, or a parent who is merely satisfied with life but is not realizing life's full potential, many have room to grow and greater satisfaction to gain from life. Others may just be trying to deal with the stress of everyday life and wishing there were some escape or change. Today, the phenomenon of inner emptiness and discontent is especially observable among young adults deciding on a career, and others dissatisfied with their work. People seem obstinately focused on the external details of life. Many act as others expect them to act and conform to the image others have of them; persuaded that they are not adequate and should fit some societal norm. Many seek adventure and risk to break from the societal norms, but without full internalized understanding of how to find the self that has been buried by the external expectations placed upon them, the duality of adventure versus duty leaves many feeling lonely, empty, frustrated, trapped and unhappy.

Conventional systems for helping others find purpose in life relate only to a portion of what a person needs to realize the possible satisfaction and advancement which can be achieved. For example, many motivational classes excite students about setting goals, achieving success, and realizing their dreams, but fail to teach the students how to overcome the internal and external struggles which will need to be faced along the way, or fail to teach the students how to set goals which are meaningful and internal to the students. In short, the courses merely add another layer of expectations to further complicate the lives of the students. In other cases, a psychologist may talk with a patient about the patient's childhood and may help them to understand their feelings and to deal with past and present relationships, but may fail to provide the knowledge to allow the patient to understand and confront other relationships in the future. One other characteristic common to many existing systems is that the educational process becomes boring to the student and is very difficult for the student to understand and internalize.

For example, many students take career tests and aptitude tests in high school to help the students to identify what may be a good career for the student. Many other students take career guidance classes and motivational classes designed to encourage the students to set and achieve goals related to the students' education. While there are high school students who, on their own or with the help of a parent or guidance counselor, set and achieve goals for future and achieve them, there are also many more other students who would rather just play a video game, read a fantasy book, or engage in some athletic activity. Some video games do teach hand-eye coordination or problem solving skills, some fantasy books do encourage creativity, and athletic activity is good for most everyone. However, these activities are not typically designed to assist the student in finding purpose, being motivated to achieve more, or finding satisfaction in life. Though interesting and desirable for the student, some of these activities are often looked at as wasteful and even destructive by others.

It would be advantageous in the art to have an educational system which engages the interest of its participants, teaches skills and knowledge necessary to face the problems of life and set goals, and does it in a way that the participants will internalize and remember the principles taught.

### DISCLOSURE OF THE INVENTION

The present invention relates to a method of instructing students to better understand themselves and to learn to identify and control themselves and their passions in order to actualize their desires to eventual success. A particular method of the invention involves communicating to a student a story, such as an adventure story, about a character, such as a hero in an adventure, using imagery which corresponds to the story and is selected as a physical metaphor representing an emotional idea. At select points throughout the story, the student is asked introspective questions, seemingly unrelated to the story, which relate to the student's experiences, beliefs and understanding. At the end of each phase of the story, the relationship between the student's responses to the questions, the imagery, the physical metaphor, and the emotional idea are explained to the student. This “imaginal synthesis”, or educational and contemplative journey to greater understanding of self through the combined use of adventure, imagery, inquiry and explanation, permits students to achieve a greater understanding of how the student's experiences, perceptions, characteristics, and fears may be administered to the development and implementation of the student's Will.

Methods of the present invention, therefore, involve adventure, imagery, inquiry and explanation. The methods of the present invention may be implemented in many different forms. Particularly, the methods may be adapted to instruct students in the form of an interactive action video game, an illustrated book, a verbal presentation, an interactive adventure park, an audio book, a video book, a media or video presentation, an interactive storyboard, an Internet link, or any other method whereby a student may be instructed using a story, imagery, inquiry and explanation. Specific lessons used in an embodiment of the invention include instructing the student in creative understanding of the student's identity, in confronting issues surrounding the student's relationships with others and in establishing the student's own identity, to identify the unknown within the student and use it to overcome and succeed in challenges, to identify and confront the student's desires and fears, to contemplate the sacrifices necessary to achieve the student's desires, and to implement and achieve the student's desires.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a flow diagram illustrating an instructive method according to an embodiment of the present invention;

FIG. 2 is a book according to an embodiment of the present invention;

FIG. 3 is an illustration of a presentation made according to an embodiment of the present invention;

FIG. 4 is an illustration of an adventure park according to an embodiment of the present invention; and

FIG. 5 is a block diagram of a computer system for use with embodiments of the present invention.

### DETAILED DESCRIPTION OF EMBODIMENTS OF THE INVENTION

Embodiments of the present invention relate to an educational system for instructing others to understand themselves and their relationships with others, to engage in introspection and reflection of the conflicts within themselves and with those around them, to face and handle those internal and external struggles, to understand their true desires and dreams, to work with their unique skills and develop new skills to overcome obstacles and achieve their dreams, and to understand that the student can achieve anything they desire using the knowledge they have gained, thus providing them with more satisfaction in life. Because embodiments of the present invention relate to an educational system, participants in the system are students. As used herein, “student” is intended to include all participants in the system, whatever the form of the system, whether the student be young or old, and whether participating in a self-study course, through individual instruction, or in a group class.

There are broadly six formative stages of understanding and instruction involved in the present system. They are: 1) Creative Understanding of Self; 2) Understanding of Personal Identity and How it Relates to Family; 3) Understanding and Synthesis of Opposites Within Self; 4) Understanding Conflicts, Complexes and Demons Within Self; 5) Contemplation of Self to Discover Habitual Patterns of Thinking, Feeling, Behavior and Actions that Affect Ability to Succeed; and 6) Awakening, Directing and Implementing Will in Consciousness to Find Purpose. Each of the six stages is progressive, building upon the knowledge, skills and experience gained by a student of the previous stages. Each stage may comprise one or more phases. By learning the knowledge and skills developed through these six stages, and the experience earned through applying each of these six stages, a student can find greater purpose in life and greater satisfaction from that purpose.

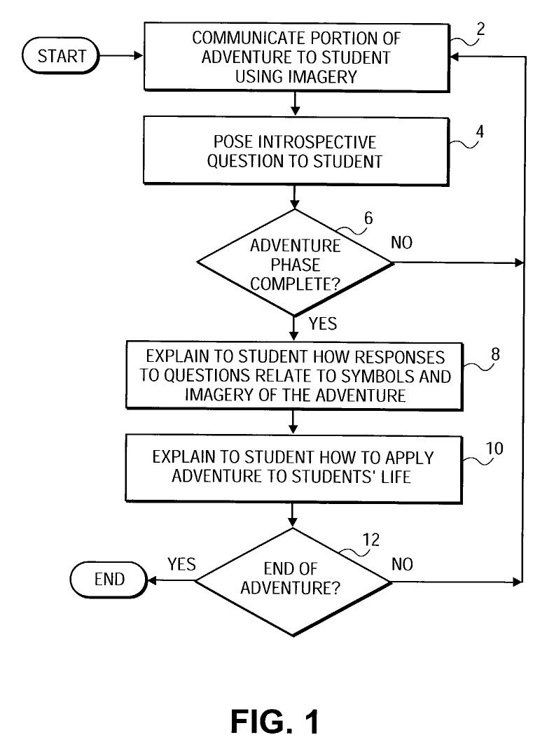

The method employed to instruct the students in a way which encourages self actualization involves four primary aspects: Adventure; Imagery; Inquiry; and Explanation. By using each of the four aspects together, it has been found that students understand the principles of the six stages more clearly, internalize and apply the understanding more completely, and maintain a deeper interest in learning and applying the principles to their lives. FIG. 1 includes a particular embodiment of an instruction method illustrating how the four aspects may be used together. A portion of an adventure in which the student has interest is communicated to the student using imagery (Step 2). At select points throughout communicating the adventure, introspective inquiries or questions are posed to the student (Step 4). The adventure is divided up into phases, and communication of the adventure (Step 2), and posing of the questions (Step 4), continues until an adventure phase ends (Step 6). At the end of an adventure phase (Step 6), an explanation is provided to the student of how the student's responses to the questions relate to the specific symbols and imagery used to communicate the adventure (Step 8), and how the student can apply the student's responses, the adventure, the symbolism and the imagery in the student's life (Step 10).

By participating in the adventure, responding to the introspective questions, and understanding the imagery used both consciously and subconsciously, the student begins to learn skills and gain the experience necessary to apply the principles in the student's life, outside of the adventure. After the final phase is completed and explanations are given, the adventure ends (Step 12). Combined use of each of these aspects of the instruction method provides a synthesis of the aspects to better instruct students to understand themselves and their relationships with others, to overcome internal and external struggles, and to find greater purpose in life.

The suspense of the adventure and the journey of the hero is the foundation for the application of the systematic process that aims at progressively and creatively eliciting elements from within the student that the student takes possession of, acquires control over, and transforms. The journey imaginatively creates a “safe” psychological distance between the student and ancestral and cultural dogmas, rules and beliefs that dominate everyone, obstacles that impede, fears that paralyze, conflicts that waste personal energies, and demons that ensnare. Characters come to life, providing the tools for the students' pursuit of meaning and sense of identity, to actualize the student's potentials and develop the student's will. The student gains experience in applying the principles being taught through the imagery involved in communicating the experiences of the hero. Through the process involved in the present invention, the student is able to achieve the highest forms of liberation: mental freedom, emotional freedom, physical freedom, and the freedom of one's true spirit.

The first aspect of the instruction method is adventure. Adventure is important to assisting a student to internalize the instruction and learn from the process for a number of reasons including, but not limited to, the following: First, by using an adventure story the student is interested in, the student enjoys the instruction more and is more likely to stay interested in and internalize the principles. Second, because many of the principles being taught through this instruction method relate to understanding one's self and relationships with others, overcoming internal and external conflicts, and recognizing and achieving purpose, communicating an adventure with a hero experiencing a variety of situations enables the student to better associate with the hero, and thereby internalize the instruction. Third, by addressing the often sensitive issues relating to internal and external conflicts, relationships with others and fears and dreams through the hero rather than the student confronting them directly, the student is able to more comfortably and “safely” address those issues and be more open to accept and apply the principles in the future.

While the adventure provided in the illustrative example below involves a quest of a knight searching for a treasure, the adventure story could involve any number of story lines, heroes and situations. The adventure of a gender neutral knight has been found to appeal well to both genders and all ages. However, it is contemplated that other adventure scenarios may be used to more specifically appeal to particular student groups. For example, the adventure may be adapted to relate better to housewives by describing a mother's adventure through a home-like setting, or adapted to relate better to a businessperson by describing a corporate world adventure with appropriate conflicts, discoveries and experiences. The key is only that the story involve a hero with whom the student can relate, in an environment conducive to the use of imagery which will communicate both consciously and subconsciously to the student.

The second aspect of the instruction method is imagery. Imagery is important to assisting a student to internalize the instruction and learn from the process because the imagery used in this process relates not only to the conscious, but to the subconscious. Imagery includes not only visual images which may be used, but detailed descriptions of the adventure which allow a student to imagine for him- or herself the imagery of the adventure. The imagery also includes the symbolism used to tell the story and instruct the student. Through the use of symbolism and images which impact not only the conscious but also the subconscious of a student, the process uses physical metaphors to express emotional ideas and introspective concepts and questions. These physical metaphors open doors to the reservoir of resources within the student, thereby allowing the student to raise their consciousness, contemplate, challenge the knowledge of their own truths, thought processes and values upon which they can rely to find their own direction, and redirect energies into constructive channels to discover exciting new possibilities for life. In combination with communicating the adventure, the process innovatively draws the student into the creative realms of the psyche to a greater understanding of oneself, discovering unknown abilities, higher potentialities, and realization of self and self-actualization.

The number of possible physical metaphors representing emotional ideas is infinite and it is believed that those of ordinary skill in the art will recognize physical metaphors representing emotional ideas without further instruction. Nevertheless, the following are a few examples provided as examples and not as limitations to the invention herein. The physical metaphor of a home being ripped apart by a tornado may represent the emotional idea of a person's inner turmoil, and the person's values and basic beliefs being torn apart, requiring a new start. The physical metaphor of a hero exploring unexplored caverns may represent the emotional idea of exploring the large and spacious unknown within ourselves. The physical metaphor of a hero traveling through the turbulent rapids of a river may represent the emotional idea of the struggle we have to maintain control of our direction in life, being thrown around in the turbulence and dangers of our existence. The physical metaphor of a hero falling into quicksand may represent the emotional idea of helplessly struggling in a situation and slowly sinking deeper. There are many, many more examples provided throughout this disclosure which are not specifically identified, but will be apparent to those of ordinary skill in the art as examples. Physical metaphors are also known to be subject to more than one possible interpretation or relationship to more than one emotional idea depending upon the context in which the physical metaphor is used, and the observer of the physical metaphor.

The third aspect of the instruction method is inquiry. Inquiry is important to further engage the student in the story, require the student to engage in introspection and see the adventure as an adventure within the student. Unlike conventional adventure stories or other text books which may ask questions relevant to the text or images on the page, the inquiry involved in the present instructive method does not ask questions relating to the story, the story line or any common fact. Rather, the inquiry involved in the present invention involves questions personal to the student. For example, when the adventure may involve the hero in a situation such as the hero's home being destroyed by a natural disaster and the hero has time to grab just three things, the student might be asked to answer the following questions: “What three things would I grab if this were my home?” “If I were to grab a childhood toy, which toy would it be?” “What was my favorite childhood game?” In another situation where the hero may be running along a steep, gravel path and slipping down the path while running from a foe, the questions might be posed: “Am I going places, or just being taken?” “Is my power being focused on materialism, fears, anger, envy, evasions or maybe even repressing emotions or projecting my personal life experiences on others around me?” “Its not what you are that holds you back, its what you think you are not. What thoughts and ideas am I holding back?” By using the imagery and adventure to establish a context for more deeply comprehending difficult questions about self, and then asking questions which help the student to contemplate and evaluate the student's self with that understanding, the student is better situated to recognize similar conflicts or adventures within him- or herself and succeed in those adventures.

The fourth aspect of the instruction method is explanation. Explanation is important to the process in that it provides further reassurance and instruction as to the meanings of the symbolism, physical metaphors and emotional ideas as they apply to life, details how the principles and skills learned in the adventure may be used in the student's life, and further encourages and motivates the student to apply the principles and skills learned. By reinforcing the understanding of the imagery used in the story with a specific explanation of what the imagery represents, how the student's responses relate to the imagery, and how the principles taught through the story can be immediately applied to and used in life, the principles and skills which are being learned by the student become more concrete.

By directly and dynamically experiencing the one's self through the progressive phases of the process of the present invention using powerful introspective concepts and questions, imagery, symbolism, adventures and an imaginal encounter with dialogue, the student will actually be able to see him- or herself and gain a better perspective and understanding of the unconscious foes of the student's inner struggles that exert an influence upon the student's behavior without conscious knowledge. The systematic process of embodiments of the present invention makes use of the methods of objectification, critical analysis, discrimination and decision making. The system allows the student to dynamically experience the adventure within him- or herself through the adventure communicated and to disidentify with the hero to safely observe the adventure without feeling threatened, thereby creating a “psychological distance” between the student and the adventure within the student. When the student returns from the adventure to find him- or herself, the student is accompanied by insight and liberation gained from the application of the combined aspects of adventure, imagery, inquiry and explanation.

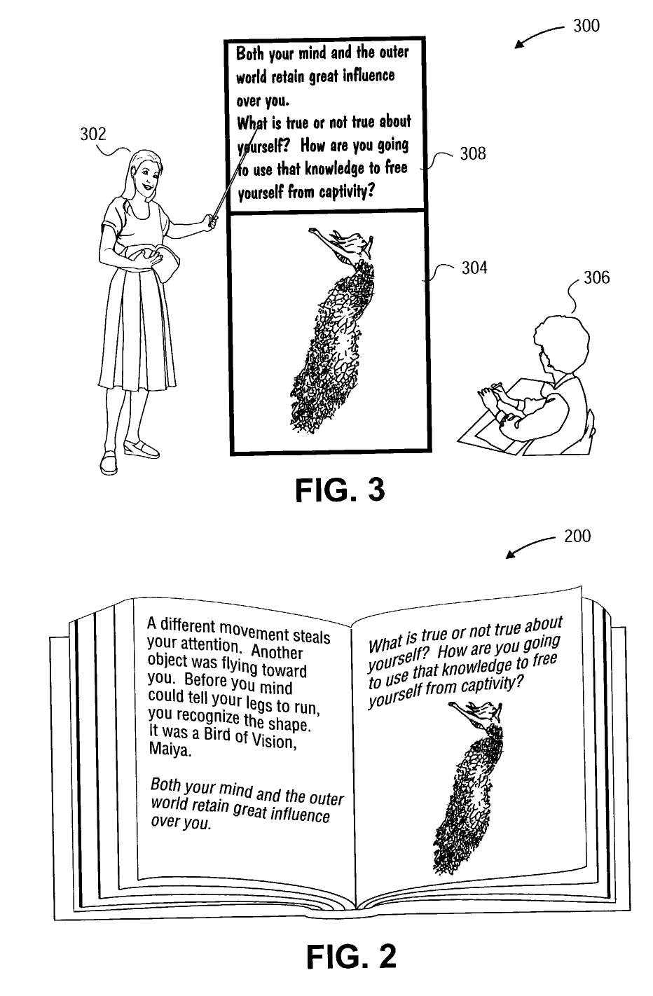

For exemplary purposes which may be applied to each stage and phase of the system of instruction described herein, and not as a limitation, the following is a specific example of how adventure, imagery, inquiry and explanation may be used in combination to instruct a student in the first stage of understanding and instruction: Creative Understanding of Self. Stated in other words, the first stage involves instructing the student to evaluate and understand the student's identity, what makes the student who the student is and why the student responds in the way the student responds. For this specific exemplary embodiment, an illustrated book 200 (FIG. 2) is used including an adventure story with imagery, inquiry and explanation. A small section of an exemplary book will be quoted here, with a written explanation of the illustrations given. This section is taken for exemplary purposes from the book “Journey of the Knight” which instructs according to some of the methods of the present invention. The book, “Journey of the Knight”, was submitted to the United States Patent and Trademark Office with provisional application No. 60/401,453 (filed Aug. 5, 2002) to Ida Covi, et al., the disclosure of which is hereby incorporated herein by reference. The book, “Journey of the Knight” is protected, however, by United States and International Copyrights which are reserved and preserved by this statement.

The adventure of this present exemplary embodiment of the method is a mythic story of a gender neutral hero on a journey for the Ancient Akashic Records, upon which all ancient wisdom, all humanities deeds, and all truth are recorded for preservation until the end of time. The second chapter of the book, titled “The Tempest—Quest 1” reads:

“You awaken feeling restless, discontent with a burning desire to seek new experiences without any clear idea of what this experience would be. You cannot shake the dream from your mind. ‘Does life have a purpose? Am I trying to understand and discover what I really want to do with my life? How can I make a difference? Where am I going? What ought I do? Have your decisions in the past been based on what others say, value and expect?

—Adjacent to this question is an illustration of a country home surrounded by lush greenery, but the illustration is skewed so that it appears to wave through the middle. The home is being disrupted somehow.—

Ponderous, you hike down the hillside path, still contemplating the curious dream. The afternoon sky turns violently black, more intense than you have ever experienced.

Have you stopped trying to achieve something because someone told you it was not important? What was it?

Suddenly, a cold wind rages fiercely, stripping the leaves from the tree branches and tossing them angrily in a continuous circular motion. A thick fog, with an unbearable stench of rotting meat, seeps in all around. Fearfully, you run back to your house and find that the storm is viciously ripping it apart board by board.

—Beneath this description is an illustration of a tornado ripping through the country home and throwing pieces everywhere. The sky is black, yet lined with an almost fiery top boarder. The house is clearly being completely destroyed.—

What is choking you? What is smoldering inside of you?

You quickly decide to run into the house and frantically grab a few items. As you struggle to find your way through the house you will be asked questions or asked to finish a sentence, using the first word or thought that comes to your mind.

As you frantically run into the house you have time to grab only three things, what would they be?

Find your favorite childhood toy; what is it?

What was your favorite childhood game?

—Adjacent to these questions is an illustration of a cozy study room which includes ornate lamps, furniture, and a short table. There is a book in the background seemingly floating in the air and an old photograph in the foreground with the words next to it “What was your favorite childhood game?”—

Seized with fear, you escape the crumbling house and run back outside into the storm. Earsplitting thunder rages. You take refuge in a dark cave that you discover in the wildwoods, not far from the ruins of what was your home.

I fear?

I treasure my ______?

—Adjacent to these questions is an illustration of an adventurer wearing a backpack and standing next to an old stone fence with a wooden gate. Lightning strikes in the background surrounded by a blackened haze.—

Deep inside the cave, stunned and exhausted, you fall upon the cold ground. A small light appears and dances upon the gray, stone walls and comes to rest in a far corner of the cave on the dirt floor. Because the large, encroaching boulders that form the low cave ceiling restrict you from standing on your feet, you crawl toward the light on your hands and knees.

I feel the most comfortable in what situations?

I am tempted by?

______ makes me happy?

—Adjacent to these questions is an illustration of a stone cave with low ceilings. The cave has hieroglyphics on the walls. In the center of the illustration is an adventurer on one knee looking at an ornate box with bright light shining from it.—

Using your hands, you dig where the small light shines and uncover a carved box. The box is ornamented with carved figures so well executed that at first sight they look alive. Rays of bright light radiate through a hairline crack in the box's cover. As you try to pry it open, another luminous, vaporous beacon from the cave's depths draws closer to you. An ancient mystic Sage is embodied.

—An illustration here includes an adventurer sitting on a stone floor on an edge of a precipice, no longer in a cave. An old man stands in front of the adventurer looking at the adventurer. The old man is wearing flowing purple robes with black flowing pants and a black hat.—

As one who is adventurous, courageous and not afraid to take risks and step beyond limits set by cultural standards you have been chosen as an “Initiate Knight”. We are calling upon you to embark on an imperative quest to find the Mountain of the Prophets and recover the ancient wisdom from within the “Akashic Records” that is being forgotten by all humans. In the past, those who had preserved and taught “The Ancient Wisdom” knew the illumination, the peace, the joy and the strength its teachings had brought into their lives. The held the knowledge to life's meaning and purpose. In the dawn of new scientific thinking, it has been lost forever from the minds of mankind. Existence will soon become sheer darkness, terror and chaos. Evil will unfold exponentially and have no consequences. Motivation will cease to exist, and no one will work out their destiny.

Only someone that has successfully conquered all fourteen trials of “The Journey of the Knight” can become a true Knight, and be able to reach the Mountain of Prophets. Once the spell is broken, you must enter the Vaults of Knowledge and reclaim the ancient wisdom from the Akashic Records. However, beware that this quest will journey through life's more perilous precipices. You will enter daunting worlds and battle ominous adversaries. Will you endeavor to experience this mythic journey?

The carved box opens and within its light lays a tarnished, gold crown with vacant niches that once held precious stones.

Upon the successful accomplishment of each trial we will bestow upon you a precious jewel for your crown. Take heed, although the jewels are valuable in your world, they are priceless in all others for they are not significant of monetary value, but earned as jewels for earthly merits. Use them wisely. Your first quest has been set in motion. Take a moment to think about your responses to the questions. The answers are trying to reveal significant clues, truths, and a deeper understanding to what types of experiences are genuinely important to the spirit inside you that is crying to express itself. Put together the scattered fragments of experiences and bits of information to recreate something new that will quiet the dark storm raging within, as you embark on the ‘Journey of the Knight.”’

For this first Quest of the book, the story engages the student reader with the adventurous story and places the hero in a situation with some degree of suspense or other aspect which would concern most readers; like a person's home being destroyed. The adventure aspect of the story (step 2), while basic during Quest 1, allows the reader to be interested in the principles and skills being taught, causes the reader to have sufficient interest in the story to continue viewing the illustrations and receiving the explanation, and enables the reader to experience what the hero is experiencing in a situation outside the reader's frame of reference. Because the story is told in second person, however, the reader's connection to the hero is still close enough to understand how the hero may be feeling and what the hero may be thinking. This connection between the reader and the hero, while not a direct connection, has been found to significantly increase the amount of learning the reader can and will safely accept.

The inquiry and imagery involved in Quest 1 (steps 2 and 4), like the adventure aspect of the story, are basic. The inquiry is directed toward eliciting an answer from the student which is not found in the story or images, but requires introspection by the student. For example, the first question asked to the student in the excerpt, “Have your decisions in the past been based on what others say, value and expect?”, requires the student to answer not necessarily upon anything which was written in the story or shown in the imagery, but upon what the student's personal experience has been, what the student is feeling at the time, and upon how the student feels about the student's relationships with others and the student's ability to control the student's own life. In other words, an introspective question elicits a response which is personal to the reader rather than one found within the story or imagery. While the imagery, story and explanations provided may provide some context for the question to elicit a better response, it cannot be answered truthfully without the student contemplating him- or herself. The imagery works with the adventure story to open the student's understanding and acceptance of the story and questions, and to put the student into a state of mind where the student can better contemplate the nature of the student's responses. On a deeper level of understanding than is likely at first glance, the physical imagery shown in the illustrations represents the emotional ideas which the questions direct the student to contemplate. Read without the questions, the story and images appear to relate to each other. Read without the imagery, many of the questions appear completely out of context with the story. However, once greater understanding as to the imagery and its underlying symbolism is achieved, it may be understood that the imagery relates to both the story and to the questions.

At more advanced phases and stages within the story, after the student has a grasp upon the basic principles being taught and the basic emotional ideas being presented, more complex emotional ideas may be presented through the imagery and more complex introspective questions may be asked which rely upon previous responses by the student. For example, at one point in the adventure, the student may be asked, “What is your most important and best memory?” Later in the story, at a different level after the explanation of how the first question relates to the imagery and emotional ideas of that level is provided, the student may be asked, in association with different imagery, “What have you learned from your most important and best memory that will assist you in maneuvering your rapids?” By indirectly referring to the student's response to the previous question, the story line does not need to know specifically what the student's response was. In this way again, the student's response to the introspective question is personal to the student and is not found in the story or the images.

The explanation which is provided at the end of each phase (steps 8 and 10), while not necessarily required for practicing the invention, provides further instruction to the student regarding the correlation between the introspective questions asked and how the student's responses to those questions relate to the imagery, the physical metaphors used, and the emotional ideas they represent. By providing the explanation, the reader better understands the connection on both a conscious and a subconscious level. In the example of the book provided above, the explanation is provided by a wise character in the story, the “Sage.” Other methods of explanation may alternatively be employed such as writing on a wall or other object, explanation by some other character, or simply by providing the explanation. However, by providing the explanation as part of the adventure story, the reader maintains a smoother connection with the story.

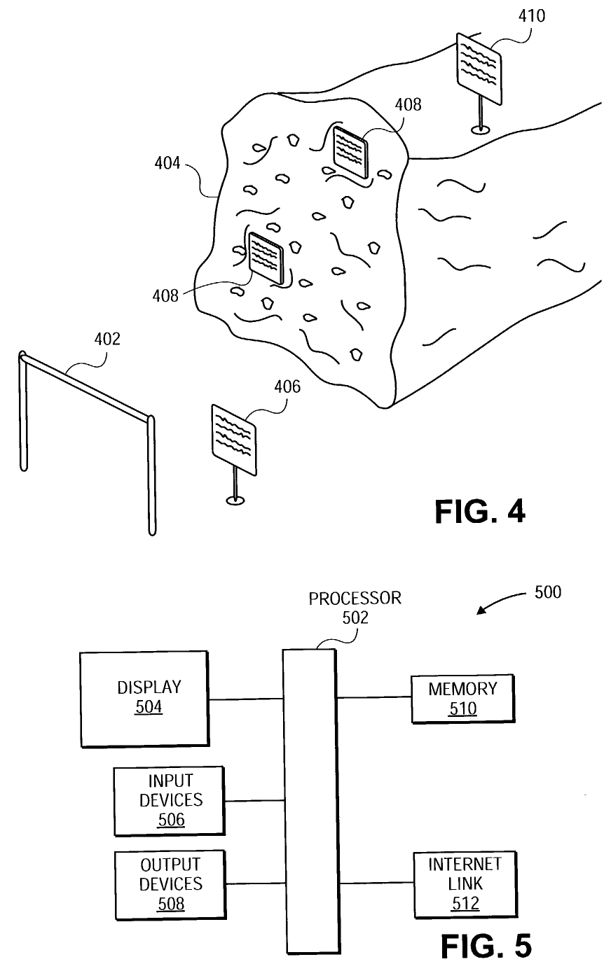

While the previous exemplary embodiment of the invention is embodied in an illustrated book, any number of other embodiments are contemplated. It is believed that the principles of the invention provided herein will readily be applicable by those of ordinary skill in the art to the other embodiments from the descriptions provided. For example, and without limitation, a presentation 300 (FIG. 3), an interactive adventure park or theme park 400 (FIG. 4), an interactive adventure video game, interactive storyboard or Internet link 500 (FIG. 5), an audio book, and a video book.

FIG. 3 includes an embodiment of the invention portrayed as a presentation 300. While illustrated as a verbal presentation of the kind which may be used in a seminar or series of lectures before an audience, this presentation may also be embodied as some other form of a media or video presentation such as through a television or video recording. As with a text embodiment of the aspects of the invention, the imagery used in the presentation may be actual illustrations 304, or merely descriptions of the imagery for the students 306 to imagine in their minds. It is contemplated that in some presentations, a presenter 302 would tell the adventure story and provide verbal explanations of the appropriate imagery, or provide some verbal and some illustrated versions of the imagery to the student 306. The presenter 302 would also pose the introspective questions 308 and the explanation to the students of how the students' responses to the introspective questions relate to the imagery and emotional ideas presented in the adventure, and how the students can apply that understanding in each of their lives. Additional motivation or words of wisdom may also be provided

FIG. 4 includes an embodiment of the invention portrayed as an interactive adventure park 400. An interactive adventure park 400 includes a plurality of imagery including actual physical challenges for students. Shown in the present embodiment is a hurdle 402 and a rock-climbing wall 404, used as examples of possible physical challenges. In addition to the physical challenges, other imagery, including any imagery which may be recognized by the senses, may be used. For example, and without limitation, it is anticipated that many of the following examples may be used as imagery acting as at least part of a physical metaphor representing an emotional idea: beautiful or ugly scenery, fog, cold, heat, smells, tastes, open or closed spaces, moisture, far or near distances between things, sharp or smooth surfaces, hard or soft surfaces, and the like. In addition to the imagery, the adventure story may be communicated where the student actually acts out many parts of the story to more closely experience the physical metaphors. The adventure story may be provided audibly by a narrator, or may be written on a sign or plaque 406 within the adventure path. The introspective questions may similarly be posed audibly or placed on a sign or plaque 408. Likewise, the explanation may be presented in an appropriate form 410. By presenting the instruction to the student through an interactive adventure park, the student may be able to learn the principles more deeply and gain greater understanding of the student's desires and how to actualize them. Alternatively, the present invention may be embodied in a theme park where all around the student is imagery embodied in a plurality of rides, venues and events, each dedicated to a principle or portion of the adventure story.

FIG. 5 illustrates embodiments of the invention incorporated into a computer presentable form. Such embodiments may be presented upon a computer system 500 having a processor 502, a visual and/or audio display 504, one or more input devices 506, such as a mouse, a keyboard, a digital pen, a joy stick, and the like, one or more optional output devices 508, such as a printer, a rumble pack (e.g. used with Nintendo and Play Station controllers), internal or external memory or data storage 510, such as random access memory (RAM), read only memory (ROM), a hard drive, a read and/or write compact disk (CD) or digital video disk (DVD) drive, and possibly an Internet Link 512.

It is contemplated that embodiments of the invention may be created to require only a processor 502, memory 510, a single input device 506, and a visual and/or audio display 504. For example, in an embodiment of the invention configured as an interactive action video game, such as a role play game (e.g. similar to the well known Balder's Gate, or Final Fantasy action video games), the game may be run on a personal computer (PC) from a CD ROM attached to the PC or loaded into the local memory of the PC. The imagery and adventure story may be displayed through the video display and speakers of the PC as the student interacts with the game, and the character may be controlled with the computer keyboard, a joy stick or other controller. Similarly, if the computer game is configured for, for example, a Nintendo or Play Station game console, only a television, a controller and a game console, which includes a processor and memory, would be necessary. To assist in maintaining the student's interest, a tally of the student's accomplishments, skill level or other measure of performance in the game, such as is common with interactive adventure video games, may be used. Distinct from conventional games such as Final fantasy or Tomb Raider, an interactive game of the present invention involves the imagery and inquiry of embodiments of the invention as well as the adventure.

For use with a computer, the invention may be embodied as an interactive storyboard which the student reads or listens to the story communicated by the computer and views the imagery on the computer display 504. Alternatively, the student may also access the story, imagery, inquiry and explanation through an Internet link 512. It is contemplated that the invention may be embodied in one or more adventures provided through the Internet so that a student can select an adventure desirable to the student, or merely to enable more students to access the instruction.

As discussed above, methods of the present invention may be implemented through a computer system 500 having a processor 502 such as a programmable logic control system, as described herein. The processor 502 is programmed with a control program that causes the associated peripheral devices, such as the displays 504, the input and output devices 506 and 508, the memory 510 and the Internet Link 512, to perform their necessary functions in associating with the processor 502 to carry out the methods described herein. The control program may be a program product in a variety of forms, and the present invention applies equally regardless of the particular type of signal bearing media to actually carry out the distribution of the program. Examples of signal bearing media include recordable type media such as floppy disks, CDs and DVDs, and transmission type media such as digital and analog communication links, including wireless communication links. The program product tangibly embodies a program of machine-readable instructions executable by a computer system having an operating system. The program product, in combination with a computer system having an operating system. The program product, in combination with a computer system, directs the computer system, such as the computer system 500 described herein, to perform the embodiments of the present invention. As such, the control program can access the memory, inputs, outputs, displays and Internet links to execute embodiments of the present invention. Essentially, the control program will contain programming to allow it to perform any of the functionality described herein. Those of ordinary skill in the art will understand how to implement the methods described in association with the present invention as a computer readable media and control program.

The computer embodiments of the invention are particularly helpful for the present generation of students who spend much of their lives interacting with the computer. For teenagers, for example, providing entertaining computer media such as an interactive action video game, which also instructs the teenager how to succeed, provides an opportunity for teaching teenagers to understand themselves and succeed which is not presently available through any other game or method. The teenagers become uniquely interested in the computer game and adventurous story which carries them through to the end of the instruction where other methods have failed for losing the interest of the teenager. For adults also, the ease of learning the principles of the present invention through a computer peaks and maintains their interest to effectively communicate the adventure story, imagery, inquiry and explanation.

The previous excerpt taken from the book “Journey of the Knight,” provides one example of a quest of the adventure relating to a limited number of principles using a select group of imagery and introspective questions and explanations. Additional examples of the adventure story, imagery, inquiry and explanation may be found within the other chapters of that book which was previously incorporated herein by reference maintaining the copyright protection therefore. Nevertheless, the following includes some examples from the book “Journey of the Knight” illustrating how certain specific principles may be taught using an adventure story, imagery involving physical metaphors of emotional ideas, introspective inquiry, and explanation. Each of these specific embodiments discussed below follow the method shown in FIG. 1. These various different specific embodiments provided as examples here may additionally be used together in sequence as a plurality of phases of a single adventure and as elements of the six stages discussed previously to more fully instruct a student to actualize his or her will and gain greater personal satisfaction in life through the method of the present invention.

In a specific embodiment of the invention for instructing a student to engage in creative understanding of the student's self, an adventure story about a hero communicates to the student imagery including physical metaphors of things important to the hero, such as the hero's home and personal belongings, being destroyed by a violent storm. At preselected points throughout the story and imagery being communicated, the student is asked introspective questions directed to helping the student understand emotional ideas relating to what may be suppressing the student's desires and what is most important to the student. Examples of these questions include: What is choking you? What is smoldering inside you? What three things would you grab? What was your favorite childhood game? I fear? I feel the most comfortable in what situations? A wise character in the story explains, among numerous other things, that without recovering the ancient wisdom which has been preserved for the hero to find, chaos, darkness and motivation will cease to exist. The wise character further explains that the student's responses to the introspective questions will reveal significant clues, truths, and a deeper understanding to what types of experiences are genuinely important to the spirit inside the student that is trying to express itself. The wise character implores the student to put together the scattered fragments of experiences and bits of information to recreate something new that will quiet the dark, storm raging within.

In another specific embodiment of the invention for instructing a student to engage in creative understanding of the student's self, an adventure story about a hero communicates to the student imagery including physical metaphors of the hero exploring unexplored caverns. At preselected points throughout the story and imagery being communicated, the student is asked introspective questions directed to helping the student understand emotional ideas relating to what the student's attitudes and beliefs are, what challenges the student has faced in life, and what has helped the student succeed in those challenges. Examples of these questions include: What opportunities have you taken? What are your three strongest beliefs? What attitudes hurt you? What is the most significant moment that you have never been able to forget? Are you aware that you may have a dark side? Do you consider your dark side bad? What is the best memory that you hold dear? What obstacles have you overcome on your journey? Who are the most important people and relationships you have met on your journey? What battles have you fought on your journey? What are your strengths? A wise character in the story explains, among numerous other things, that the hero should recognize the opportunity and make the commitment to investigate the mysterious caverns of the hero's existence. It is a quest into your Reality, consciousness and mental empowerment. The wise character further advises that it is essential to liberation to become consciously self-aware and probe into what shapes your reality. Exercise the valuable power you hold as the mediator between the inner and outer aspects of your life. Use your intellect, your logical mind, to shape your existence. If you interpret your past and understand your present, you can shape your future.

In a specific embodiment of the invention for instructing a student to evaluate the student's self and relationships with others, an adventure story about a hero communicates to the student imagery including physical metaphors of the hero on a turbulent ride through a rapid river. At preselected points throughout the story and imagery being communicated, the student is asked introspective questions directed to helping the student understand emotional ideas relating to what the student has learned through the student's life experiences and relationships which will help the student succeed in future life challenges. Examples of these questions include: Who is the guardian of your soul? Who holds the key? What did you learn from your childhood family that you want to take with you on your raft down the rapids? What did you learn from the moment in your life that you were never able to forget, that you want to take with you on this adventure? What have you learned from your dark side that will aid you on your trip? What did you learn from the important people and relationships in your life, that you want to take with you down the rapids? What have you learned from the obstacles that you have encountered that will aid you on your quest? What have you learned from your most important and best memory that will assist you in maneuvering the rapids? What skills did you learn from battles that will aid you on your trip down the rapids? How do you get your ideas? How do you see the world? Why do you see the world the way you do? A wise character in the story explains, among numerous other things, that seeing the world from other positions opens possibilities. Within you is the key that can unlatch a universe of mysteries, possibilities and opportunities. The wise character further explains, examine events, the different aspects of yourself, and consider their value; things may not be what they initially appear to be or they may bring in opportunities. Strive to discern what things in your life are either enriching or non-productive. As in this quest, white water rafting may thrill your spirit and give you a feeling of accomplishment. White water rafting put you in touch with yourself, your nature, rather than trying to escape from yourself. Attempt to better understand what you are trying to escape from.

In another specific embodiment of the invention for instructing a student to evaluate the student's self and relationships with others, an adventure story about a hero communicates to the student imagery including physical metaphors of the hero traveling through a party with drugs and alcohol in an ancient temple with rewards and dangers resulting from choices made by the hero. At preselected points throughout the story and imagery being communicated, the student is asked introspective questions directed to helping the student understand emotional ideas relating to what barriers and distractions are thwarting the student's endeavors and corrupting his time and mind, and what interests the student has in life. Examples of these questions include: What distractions are thwarting your endeavors and corrupting your time and mind? What steps can you take to overcome the emotions of hopelessness that are sinking you? What are you curious about? What good ideas or interests do you desire to pursue? A wise character in the story explains, among numerous other things, that the modern age seems obstinately focused on the external details of life. We act as others expect us to act. Caught up in the personal conflict we face, as we encounter the duality of adventure versus duty, many feel lonely, empty, frustrated, trapped and unhappy. You have a critical role in determining what is going on in your life and going into your subconscious. The world can seem barren and leave you in despair. Don't run the risk of digging a hole for yourself or let others sink you. Learn to meditate and reach past the barriers that separate you from the deepest creative parts of yourself.

In another specific embodiment of the invention for instructing the student to evaluate the student's self and relationships with others, an adventure story about a hero communicates to the student imagery including physical metaphors of the hero climbing a mountain, selecting a safe and appropriate path. At preselected points throughout the story and imagery being communicated, the student is asked introspective questions directed to helping the student understand emotional ideas relating how the student will engage challenges and the source of the student's motivation to engage the challenges. Examples of these questions include: How do I ascend? What is your reason for ascending . . . money or elevation of spirit? Are you able to accept the doubt and uncertainty involved in whether you can make this move? Do you think that the move is within your limits? A wise character in the story explains, among numerous other things, that desire and ambition must be protected and contained, and must not motivated primarily by money or other external motivators. Curiosity enables you to climb higher and your spirit will learn and flourish. Being able to accept doubt and uncertainty allows you to be flexible, and flexibility allows for the revision of initiatives advancing your ideas and desires into reality. Concentration and attention to detail by avoiding distractions is critical to all achievements. Skillful mentors can teach much. Planning a path prior to beginning the journey and regularly reevaluating the prudence of the path to determine if changes are necessary is important. Watch the signs that a change in path is needed. While resting always be looking for your next move.

In yet another specific embodiment of the invention for instructing a student to evaluate the student's self and relationships with others, an adventure story about a hero communicates to the student imagery including physical metaphors of the hero traveling through an ancient place. At preselected points throughout the story and imagery being communicated, the student is asked introspective questions directed to helping the student understand emotional ideas relating to the student's traditions, the student's family's traditions, and the student's relationships with others in the student's past. Examples of these questions include: Who in your past has been the most critical of you? Which person growing up was the most important for you to please? Which person growing up pushed you the hardest to achieve? Are you afraid someone will stop loving you? What family rule or tradition no longer suits your needs and are you most in conflict with or afraid of breaking? What old rule or tradition is keeping you from pursuing or exploring interests? Why did this rule or tradition come to be? Do these reasons still exist? How can you let the old rule or tradition go now? What are you most afraid of on this journey? A wise character in the story explains, among numerous other things, that there is no truth as vital as being yourself. Challenge old beliefs, fears and traditions. Unchallenged, these fears, beliefs and rules have great powers, obstructing true understanding and intimacy of one-self. These ancient voices are excessively more severe than our ancestors because they come from the fantasy of our mind where we give them power to correspond equally in strength to the defense we struggle to use against them. Follow your own truths for you are here to express yourself. Do not be a copy of someone else.

In a specific embodiment of the invention for instructing a student to identify the unknown aspects of the student's identity and use it to overcome and succeed in challenges, an adventure story about a hero communicates to the student imagery including physical metaphors of the hero appearing as two heroes working together to survive in a physically demanding environment. At preselected points throughout the story and imagery being communicated, the student is asked introspective questions directed to helping the student understand emotional ideas relating to the student's feminine and masculine elements. Examples of these questions include: What is your feminine element's deepest wish for you? What is your masculine element trying to teach you? What do you not like about the female aspects of yourself? What do you not like about the male aspects of yourself? What can you do to respect each of your wishes? A wise character in the story explains, among numerous other things, that you should recognize and honor your feminine and masculine elements and lead them to a state of mutual cooperation and coexistence. These opposites are essential to each other's success and inspire one another in order to make you a single whole greater than the sum of your parts. With all your aspects cooperating and striving for common objectives, a new strength and power becomes available to you.

In another specific embodiment of the invention for instructing a student to identify the unknown aspects of the student's identity and use it to overcome and succeed in challenges, an adventure story about a hero communicates to the student imagery including physical metaphors of the hero traveling through an ancient ruin which is eroding away from extended exposure to the elements. At preselected points throughout the story and imagery being communicated, the student is asked introspective questions directed to helping the student understand emotional ideas relating to the student's passions, what may be diminishing the student's passions, and what strengths and motivation the student may have to pursue the student's passions. Examples of these questions include: What are your passions? What is eroding your passion? What is poisoning your passion? What disguises are you using to conceal your passion? Are you losing faith in your path? What strengths are you using to pursue your passion? What is the motivating force energizing your passion? A wise character in the story explains, among numerous other things, that passions should be reclaimed from the sand where they have been safely stowed away in secret caves and crypts, their very existence doubted. Perpetuate your passions within your temple where they can be shielded from being poisoned, protected from crumbling to dust or lost in a deep gorge, for they are the very meaning of your experiences.

In a specific embodiment of the invention for instructing a student to identify and confront the student's desires, fears, doubts and vulnerabilities, an adventure story about a hero communicates to the student imagery including physical metaphors of the hero running a long distance marathon and encountering obstacles during the run such as falling down a rocky, slippery slope, encountering a beast and other distractions along the way, and feelings of exhaustion. At preselected points throughout the story and imagery being communicated, the student is asked introspective questions directed to helping the student understand emotional ideas relating to who or what is controlling the student's path and how the student is using the student's energies. Examples of these questions include: Are you going places, or just being taken? What devitalizing or destructive ways do you express your energy? Is my power being focused on materialism, fears, anger, envy, evasions or maybe even repressing emotions or projecting my personal life experiences on others around me? What thoughts/ideas are holding you back? Am I destroying my energy without my awareness? A wise character in the story explains, among numerous other things, that deep within us all lies a raw, but fluid, energy that can be transformed into various forms of expression. Unfortunately, a large amount of this energy is often expressed through a familiar family pattern such as anger, materialism, greed, abuse, envy of others, being critical or perfectionistic. Use reason, knowledge and discipline in how these emotional experiences are expressed. Fears and pains that lie deep within the mind arising from childhood and adult experience limit us and prevent our development. As experienced in the marathon, you may at times subject yourself to physical extremes to force your will, courage, strength and consciousness beyond self imposed limits. The limits of your performance are set not just by your genes but by your head as well.

In another specific embodiment of the invention for instructing a student to identify and confront the student's desires, fears, doubts and vulnerabilities, an adventure story about a hero communicates to the student imagery including physical metaphors of the hero crossing a frozen mountainside to achieve a goal and confronting demons along the way. At preselected points throughout the story and imagery being communicated, the student is asked introspective questions directed to helping the student understand emotional ideas relating to the student's passions, fears, doubts and vulnerabilities and ability to pursue the passions. Examples of these questions include: What types of activities make you feel ‘passionately alive’? For what reasons would you like to withdraw or hide? Have you lost the power to choose? Are you wasting time looking back? At what? In what ways are you feeling pressured to conform to societal shoulds? What keeps you from asking more probing questions? Why do you let other people 's opinions have power over you? What are you curious about? What longings echo inside of you? What hungers call to you in the stillness? Which activities that you are involved with help you grow the most interesting possibilities for your passions? How can you help your passions take root? What actions can you take to further your passions? A wise character in the story explains, among numerous other things, that it takes three essential elements to accomplish almost anything: wisdom, passion and power. Passion creates the desire to will an act. Passion without power and wisdom is merely aimless surges of emotion without purpose. Be relentless in seeking what you love. Then find the courage to follow its path with everything you have got. Follow the call to silence often and seek the radient sentinel star that burns inside you, that severs your light from darkness. Only in stillness is knowledge revealed. Be cautious, for once the seeker discovers who he or she truly is, the challenge is to be true to yourself from that day on and never again betray yourself. Otherwise you must return to this place of darkness.

In yet another specific embodiment of the invention for instructing a student to identify and confront the student's desires, fears, doubts and vulnerabilities through confronting the student's choices, experiences, changes and crossroads, an adventure story about a hero communicates to the student imagery including physical metaphors of the hero making moral choices and experiencing the consequences of the choices. At preselected points throughout the story and imagery being communicated, the student is asked introspective questions in the form of moral choices directed to helping the student understand emotional ideas relating to the importance of the student applying the student's knowledge to each thought, choice and decision made by the student to show that each decision will have future consequences. Examples of these moral choices include: Will you give your small room to a woman and her sick child? Will you throw away a gift given you by the child? Will you risk your safety for the benefit of others? Will you share of your abundance with the needy? Will you read a letter addressed to another without permission? Will you take food and water which is not yours without permission? Will you risk your life for another? A wise character in the story explains, among numerous other things, that life is an ongoing adventure of purposeful experiences and relationships enabling you to experience the dynamics of freedom of choice in correlation to cause and effect in order to find your true self. Each of us contains many urges, behaviors and conflicting emotions that must be resolved in the soul's educational process of discovering “who am I?” We may not find the meaning of life today or even tomorrow, but we can find many meaningful experiences that open other doors to us.

In still yet another specific embodiment of the invention for instructing a student to identify and confront the student's desires, fears, doubts and vulnerabilities through confronting the student's power of perception, an adventure story about a hero communicates to the student imagery including physical metaphors of the hero reading and following a map to reach a plurality of checkpoints and overcome an obstacle at each checkpoint. At preselected points throughout the story and imagery being communicated, the student is asked introspective questions directed to helping the student understand emotional ideas relating to the student mastering the clear power of perception and interpreting perceptions into active administration of work and action through the student's honesty with himself, powers of discernment, confident intentions, perseverence and active administration of work or action. Examples of these questions include: Are you participating in life or are you waiting for that future experience that brings happiness to happen to you? What important challenges face you at this time? What conflicting forces hold the most power over you in facing these challenges? What are your choices when facing these challenges? What are the motives fueling each choice? What can you do to incite yourself to action? What illusions do you have about how life is supposed to be? What provides you with a sense of profound meaning? With ruthless honesty and considerable powers of discernment, evaluate all things that are useful or not, including your actions, behaviors and attitudes that you can eliminate that are weighing you down or are actually the obstacles on your journey to find your ideals and aspirations? A wise character in the story explains, among numerous other things, that by mastering the clear power of observation and interpreting it into wisely directed action, you keep life on the road of meaning. In the process you learn to weigh experiences that occur in your life. Like the spider that unwearingly spins her web with the skill of a craftsman, sometimes trying again and again until she has it right, you must craft your life. You must assume responsibility for yourself. Resistance encountered and practice makes you stronger and sharper, continually increasing your skill and power.

In a specific embodiment of the invention for instructing a student to self observe his own habitual personality traits to achieve the student's desires, an adventure story about a hero communicates to the student imagery including physical metaphors of the hero facing adversaries and removing the adversaries' masks to reveal their underlying faces and eventually their true face. At preselected points throughout the story and imagery being communicated, the student is asked introspective questions directed to helping the student understand emotional ideas relating to the attitudes, emotions, behaviors and personality of the student and the correlation between those attitudes, emotions, behaviors and personality of the student and the student's central operating principle. Examples of these questions include: Do you ever ask yourself what is the reason for the circumstances in your life? Which circumstances in particular? Do you have the ability to face up to the true situation within yourself together with the willingness to change it? Identify at least two of your frequent visible personalities and give each of them a name? Identify and record the habitual actions and behaviors of each of your visible personalities? Identify and record the automatic responses of emotions or attitudes, which characterize your visible personalities? What is the point of focus or the central operating principle around which the various visible personalities all rotate; the point served by your habitual patterns? What must I do to stop or remove myself from these behaviors? A wise character in the story explains, among numerous other things, that the strong tendency to be primarily directed and influenced in life from the Masked Giant is the very thing which most directly keeps you from getting on with your life's mission. In discovering your life's purpose, it is a highly significant step, to understand as many visible personalities of your wheel as possible. Remember that these behaviors, attitudes and emotions are lived in an automatic, unconscious, habitual fashion and are subservient to your ‘central operating principle, or the Masked Giant. The self-observing discipline of staying familiar with your personality and its habits is an ongoing, lifetime work. Your mission is not to destroy the Giant at the center of your wheel, but instead to learn how to free yourself from his powerful and automatic hold on you. Continue your quest by fully recognizing the influences within yourself that keep you from being able to see and to live life with greater meaning and purpose.

In a specific embodiment of the invention for instructing a student to implement and achieve the student's desires based upon the student's understanding of the student's self, an adventure story about a hero communicates to the student imagery including physical metaphors of the hero contemplating the hero's exploration and ability to direct and implement his Will to shape his desires, environment, and interactions. At preselected points throughout the story and imagery being communicated, the student is asked introspective questions directed to helping the student understand emotional ideas relating to the student directing his life through the development of his Will, the student's satisfaction with the student's environment, administration of the student's path in life, motivation to achieve desires, and power over the student's self. Examples of these questions include: Can you be happy without the display of success to your outer world? Can you learn to be happy just for your inner world, for yourself? What is really at stake behind the drama that is being acted in your life? What is your payoff in retaining a belief that prevents something you desire in life from manifesting? What motives inspire action in you? What are your true motives? Identify the strengths and qualities within you that are necessary to get through the situation? In the course of experience, how does your awareness, mind and will interact? Dare you have the courage to be who you really are? What is true or not true about yourself How are you going to use that knowledge to free yourself from captivity? How will you maintain that place of truth? How awakened is your Will? Is your mind a servant of the Will of your True Spirit? Or is your Will a servant of your mind? A wise character in the story explains, among numerous other things, that we manifest who we think we are based on influences of our past, not as our true spirit sees it. If you can root out and eradicate each and every underlying weed of personal interest or selfish gratification, your true, uncorrupt motive by which a decision is made can be isolated. Each person, in their own private way, at their own pace, is working toward their purpose. Know that you need to carefully balance your outer world to your inner world, your logical intellect to your feelings, and your mind to your heart. Be in charge, manage, direct and be creative with your life, otherwise you remain captive to your fears, doubts and ignorance. Do not limit your spirit, set it free.

As is illustrated by the foregoing examples, it may be said that the adventure story and imagery sets a backdrop or broad context for the introspective questions to be asked. Although the introspective questions are seemingly unrelated to the story and illustrations, the explanation provided at the end of each phase ties the student's responses to the questions to the physical metaphors used in the imagery to make an instructional point. Through receiving instruction by an embodiment of this method, the student is able to more fully understand and internalize the principle not only on a logical level, but on emotional and spiritual levels as well. Not only consciously, but subconsciously. As was mentioned earlier, the series of examples immediately preceding this paragraph may all be used sequentially to instruct a student. In this combined embodiment, the sequential application of these instructive principles taught through a method of the present invention results in the student's understanding and ability to receive instruction to be broadened by the preceding phases of instruction. In other words, later phases are able to build upon previous phases, relying upon a student's responses to previous questions, and introducing more and more complicated emotional concepts and imagery. Where the initial introspective questions posed in this instructive process relate to more superficial issues such as what was your favorite childhood game?, and I am tempted by?, later introspective questions require the student to have a much deeper understanding of the student's self to answer questions such as what are your true motives?, and in the course of experience, how does your awareness, mind and will interact? These deeper psychoanalytically introspective questions are possible because the student has gained additional insight and understanding through earlier phases of instruction.

The embodiments and examples set forth herein were presented in order to best explain the present invention and its practical application and to thereby enable those of ordinary skill in the art to make and use the invention. The psychological terminology and other ideas and terminology expressed herein are disclosed with sufficient detail to enable those of ordinary skill in the art to apply the educational process of the present invention. To further the clarity of the abstract concepts included in this disclosure, numerous examples have been provided. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A method of instructing a student to succeed, the method comprising:
communicating to the student a story about at least one character, the story comprising a plurality of imagery which corresponds to the story, wherein the imagery is each selected as a physical metaphor representing at least one emotional idea;
asking the student a plurality of introspective questions relating to the student's experiences and beliefs at preselected points in the story while communicating the story to the student through the imagery; and
explaining to the student how responses by the student to the introspective questions asked relate to the imagery, the physical metaphor, the emotional idea and at least one of the character and the student.

2. The method of claim 1, wherein communicating to the student the story about the character comprises communicating a story to the student using a second plurality of imagery more complex than a first plurality of imagery, the method further comprising: asking the student a second plurality of introspective questions relating to the student's experiences and beliefs in conjunction with communicating the second plurality of imagery, which questions include references to answers provided by the student in response to a previous plurality of introspective questions while the first plurality of imagery was communicated.

3. The method of claim 1, wherein communicating the story comprises communicating the story through an interactive action video game.

4. The method of claim 1, wherein communicating the story comprises communicating the story through an illustrated book.

5. The method of claim 1, wherein communicating the story comprises communicating the story through a spoken presentation.

6. The method of claim 1, wherein communicating the story comprises communicating the story through an interactive adventure park.

7. The method of claim 1, wherein communicating the story comprises communicating the story through at least one of an audio book, a video book, a media presentation, a video presentation, an interactive storyboard, and an Internet link.

8. The method of claim 1, further comprising providing motivational advice to the student related to the imagery and the emotional ideas.

9. The method of claim 1, wherein the method of instruction comprises successive lessons which build upon previous lessons, each lesson involving communicating a portion of the story about the character, asking introspective questions to the student, and explaining how the student's responses relate to the imagery and the emotional ideas, the student having an identity, relationships with others, conflicts, fears, doubts and vulnerabilities, personality traits and Will, the method further comprising:
at least a first lesson which instructs the student in creative understanding of the student's identity;
at least a second lesson which instructs the student in confronting issues surrounding the student's relationships with others and in establishing the student's identity distinct from the student's relationships with others;
at least a third lesson which instructs the student to identify unknowns within the student and use the unknowns to overcome and succeed in challenges;
at least a fourth lesson which instructs the student to identify and confront the student's conflicts, fears, doubts and vulnerabilities;
at least a fifth lesson which instructs the student to self observe the student's personality traits to achieve the student's desires;
at least a sixth lesson which instructs the student to implement and achieve the student's desires through exploration and an internal ability of the student to implement and direct the student's Will.

10. The method of claim 1, further comprising instructing the student to engage in creative understanding of the student's self, the instruction comprising communicating to the student imagery including physical metaphors of things important to the character being destroyed, and asking the student introspective questions directed to helping the student understand emotional ideas relating to what may be suppressing the student's desires and what is most important to the student.

11. The method of claim 1, further comprising instructing the student to engage in creative understanding of the student's self, the instruction comprising communicating to the student imagery including physical metaphors of the character exploring unexplored places, and asking the student introspective questions directed to helping the student understand emotional ideas relating to what the student's attitudes and beliefs are, what challenges the student has faced in life, and what has helped the student succeed in those challenges.

12. The method of claim 1, further comprising instructing the student to evaluate the student's self and relationships with others, the instruction comprising communicating to the student imagery including physical metaphors of the character on a turbulent ride through an environment, and asking the student introspective questions directed to helping the student understand emotional ideas relating to what the student has learned through the student's life experiences and relationships which will help the student succeed in future life challenges.

13. The method of claim 1, further comprising instructing the student to evaluate the student's self and relationships with others, the instruction comprising communicating to the student imagery including physical metaphors of the character traveling through a distractive surrounding with rewards and dangers resulting from choices made by the character, and asking the student introspective questions directed to helping the student understand emotional ideas relating to what barriers and distractions are hindering endeavors of the student and corrupting at least one of the student's time and mind, and what interests the student has in life.

14. The method of claim 1, further comprising instructing the student to evaluate the student's self and relationships with others, the instruction comprising communicating to the student imagery including physical metaphors of the character climbing a mountain, and asking the student introspective questions directed to helping the student understand emotional ideas relating how the student will engage challenges and the source of the student's motivation to engage the challenges.

15. The method of claim 1, further comprising instructing the student to evaluate the student's self and relationships with others, the instruction comprising communicating to the student imagery including physical metaphors of the character traveling through an ancient place, and asking the student introspective questions directed to helping the student understand emotional ideas relating to the student's traditions, the student's family's traditions, and the student's relationships with others in the student's past.

16. The method of claim 1, further comprising instructing the student to identify the unknown aspects of the student's identity and use it to overcome and succeed in challenges, the instruction comprising communicating to the student imagery including physical metaphors of the character appearing as two characters working together to survive in a physically demanding environment, and asking the student introspective questions directed to helping the student understand emotional ideas relating to the student's feminine and masculine elements.

17. The method of claim 1, further comprising instructing the student to identify the unknown aspects of the student's identity and use it to overcome and succeed in challenges, the instruction comprising communicating to the student imagery including physical metaphors of the character traveling through a place suffering from environmental erosion, and asking the student introspective questions directed to helping the student understand emotional ideas relating to the student's passions, what may be diminishing the student's passions, and what strengths and motivation the student may have to pursue the student's passions.

18. The method of claim 1, further comprising instructing the student to identify and confront the student's desires and fears, the instruction comprising communicating to the student imagery including physical metaphors of the character running a long distance and encountering obstacles during the run, and asking the student introspective questions directed to helping the student understand emotional ideas relating to who or what is controlling the student's path and how the student is using the student's energies.

19. The method of claim 1, further comprising instructing the student to identify and confront the student's desires, fears, doubts and vulnerabilities, the instruction comprising communicating to the student imagery including physical metaphors of the character crossing a frozen mountainside to achieve a goal and confronting demons along the way, and asking the student introspective questions directed to helping the student understand emotional ideas relating to the student's passions, conflicts, complexes and personal demons, the student's ability to understand the conflicts, complexes and personal demons, to overcome them, and to pursue the student's passions.

20. The method of claim 1, further comprising instructing the student to identify and confront the student's choices, experiences and changes, the instruction comprising communicating to the student imagery including physical metaphors of the character making choices and experiencing the consequences of the choices, and asking the student introspective questions directed to helping the student understand emotional ideas relating to the importance of the student applying the student's knowledge to thoughts, choices and decisions of the student.

21. The method of claim 1, further comprising instructing the student to identify and confront the student's power of perception, the instruction comprising communicating to the student imagery including physical metaphors of the character reading and following a map to reach a plurality of checkpoints, and asking the student introspective questions directed to helping the student understand emotional ideas relating to the student's honesty with himself, power of discernment, confident intention, perseverance, and active administration of work or action.

22. The method of claim 1, further comprising instructing the student to self observe habitual personality traits to achieve the student's desires, the instruction comprising communicating to the student imagery including physical metaphors of the character facing adversaries and removing the adversaries' masks, and asking the student introspective questions directed to helping the student understand emotional ideas relating to habitual attitudes, emotions, behavior and personality of the student and the correlation between those attitudes, emotions and personalities of the student and a central operating principle of the student.

23. The method of claim 1, further comprising instructing the student to awaken, direct and implement the student's Will based upon the student's understanding of the student's self, the instruction comprising communicating to the student imagery including physical metaphors of the character contemplating exploration by the character and an ability of the character to direct and implement his Will to shape his desires, environment and interactions, and asking the student introspective questions directed to helping the student understand emotional ideas relating to the student directing his life through developing the student's Will, and using the student's Will to shape the student's environment, administration of the student's path in life, motivation to achieve desires, and power over the student's self.

24. A method of instructing a student to learn about self using an interactive video game, the method comprising:
engaging a student to play an interactive action video game through which the student controls at least some actions of a character in the interactive action video game;
displaying to the student, through images for the interactive action video game, imagery which corresponds to an environment for the video game and the actions of the character in that environment, wherein the imagery is each selected as a physical metaphor representing at least one emotional idea;
asking the student a plurality of introspective questions relating to the student's experiences and beliefs at preselected points in the video game while the student is playing the video game; and
explaining to the student, through the interactive action video game, how responses by the student to the questions asked relate to the imagery, the emotional idea and at least one of the character and the student.

25. The method of claim 24, wherein engaging the student to play the interactive action video game comprises tracking at least one of the student's progress and ability in understanding how the student's responses to the questions asked relate to the imagery and the emotional idea through a score.

26. The method of claim 24, wherein explaining to the student how the student's responses to the questions asked relate to the imagery and the emotional idea through the interactive action video game is at least partially accomplished through a dialog of a wise character of the interactive action video game.

27. The method of claim 24, wherein displaying to the student imagery selected as a physical metaphor representing at least one emotional idea comprises displaying a first set of imagery in a first level of the interactive action video game representing a first set of emotional ideas, and displaying a second set of imagery in a second level of the interactive action video game representing a second set of emotional ideas which build upon the first set of emotional ideas.

28. A method of instructing a student to succeed through communicating an adventure story to the student, the method comprising:
communicating to the student an adventure story wherein a hero in the adventure story faces a plurality of challenges, wherein the adventure story comprises a plurality of imagery selected as physical metaphors representing emotional ideas including at least one of loneliness, serenity, danger, accomplishment, fear, self observation, doubt, vulnerability, aspiration and exploration;
asking the student a plurality of introspective questions which are seemingly unrelated to the adventure story, the introspective questions relating to how the student's experiences or beliefs relate to the emotional ideas; and
explaining to the student through a wise character in the adventure story how the student's responses to the questions asked relate to the imagery and emotional ideas, and how the student can overcome challenges through understanding how the student's experiences and beliefs affect the student's life.
